(19) United States
(12) Patent Application Publication
(10) Pub. No.: US 2005/0104440 A1
(43) Pub. Date: May 19, 2005

(54) Rim cover

(76) Inventor: George Aloysius Culbert III, Keystone Heights, FL (US)

Correspondence Address: GEORGE ALOYSIUS CULBERT III, 553 S. E. 42ND ST, KEYSTONE HEIGHTS, FL, 32656, US

(21) Appl. No.: 10/706,572

(22) Filed: Nov. 13, 2003

(51) Int. Cl. B60B 7/00

(52) U.S. Cl. 301/37.104

(57) ABSTRACT

The rim cover is designed as a simple tool to be used in the automobile detailing sector. Specifically when applying a chemical protectant to the tires. The rim cover is placed over the tire rim to impede excessive spray and mist when applied by low-pressure devices from settling on the rim. The intended effect of the rim cover is to aid in keeping the rim cleaner longer and to reduce work and time spent on the rim by not having to reclean it after having sprayed the tire.

### BACKGROUND OF THE INVENTION

The rim cover was designed to be used when detailing an automobile/vehicle tire. When spraying a protectant chemical on a tire, excessive spray and mist also get on the surface of tire rim. This residue quickly collectes dirt and dust. When placed over the rim, the rim cover impedes excessive spray and mist from settling on the rim. The effect of the rim cover is that the rim stays cleaner longer and time/work is reduced by not having to wipe the protectant off the rim.

### BRIEF DESCRIPTION OF THE INVENTION

The rim cover as the name suggests is meant to cover the outer surface of the automobile/vehicle tire rim. When chemical protectents are being applied to the automobile tire, the rim cover impedes excessive spray mist from coming into contact with the rim.

### DETAILED DESCRIPTION OF THE INVENTION

The rim cover is an invention designed to be utilized when applying chemical protectants to an automobile/vehicle tire. It is made of molded plastic 1/16″ in thickness. When being used, it is placed over the tire rim just prior to the protectant being applied. Protectant is applied to the tire in the last phase of automobile detailing usually by some form of spraying. This is done just after the automobile has been washed, dried, waxed, and buffed. This is because it would be rinsed off during the washing process. If applied before buffing off the wax, wax dust adhere to the protectant as it becomes sticky during the drying process. As the protectant is used last, excessive spray and spray mist inadvertently gets on the clean rim. If left on the rim, dust and dirt quickly collect on the drying, protectant. The only alternative is to take the time to once again clean the rim. By placing the rim cover over the rim, the rim is protected by impeding the excessive spray from settling on the rim. Thus, the rim cover eliminates an extra phase in the detailing process. This saves the user both time and extra work.

The rim cover consists of three sections. These three sections will make up a single unit of molded plastic 1/16 of an inch in thickness. Each unit is a complete product ready to be used as produced. Below is listed a description of each view of the drawing along with an explanation of the design.

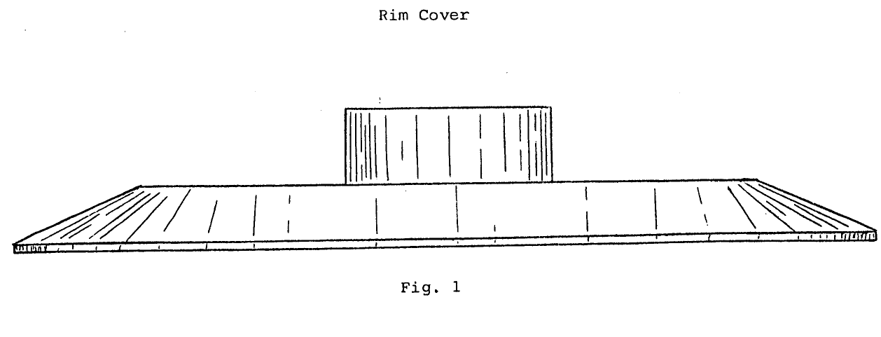

1. Rim Cover (FIG. 1): This drawing is a three dimensional side view of the rim cover showing the item from this perspective.

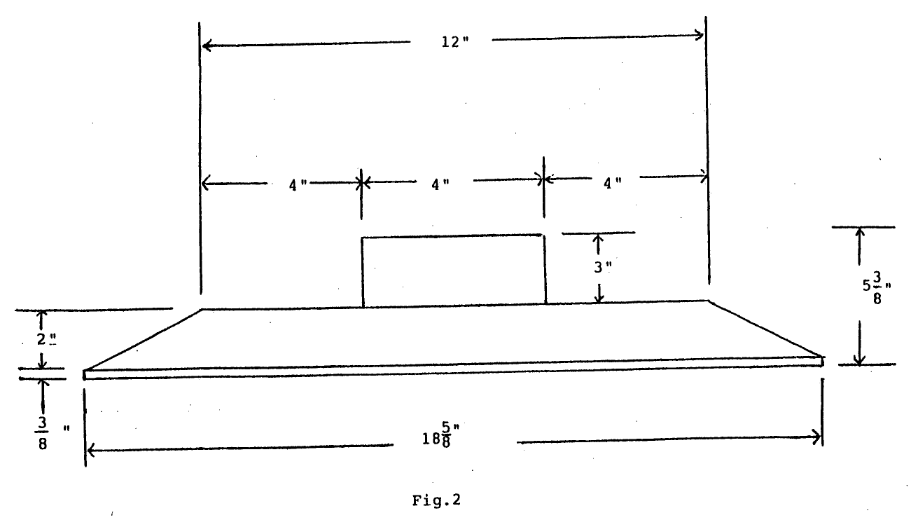

2. Measurement Drawing (FIG. 2): This side view drawing shows the measurements of each section of the rim cover based on a rim 18″ in diameter and without an extended hub. The measurements shown will vary for production purposes to accommodate the various rim sizes.

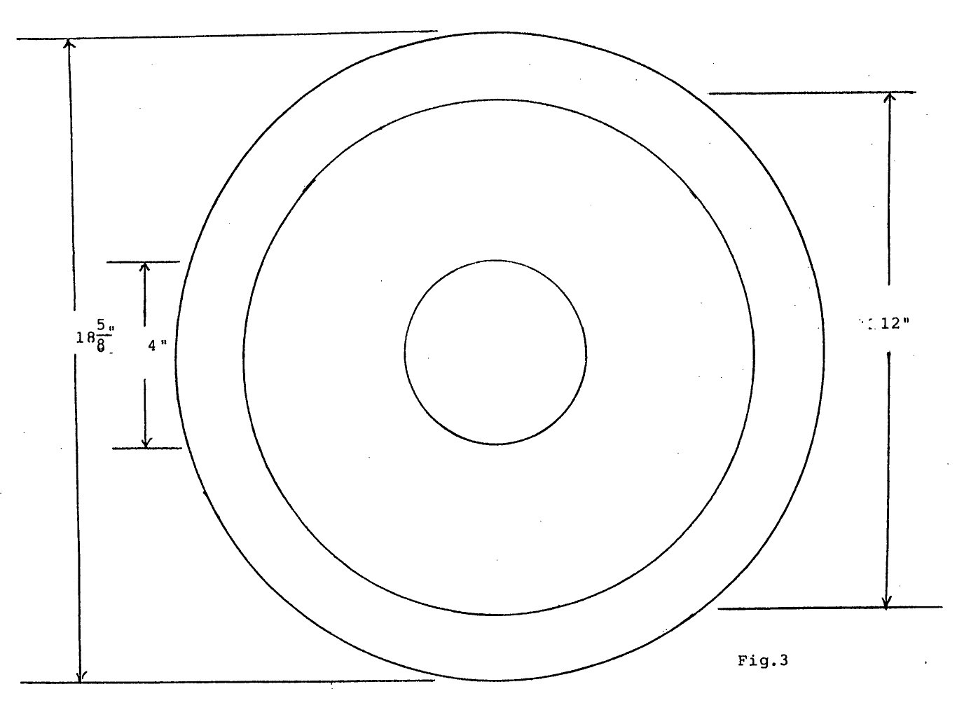

3. Measurement Drawing (FIG. 3): This top view drawing shows the measurements of this perspective based on a rim 18″ in diameter without a hub. The measurements shown will vary for production purposes to accommodate the various rim sizes.

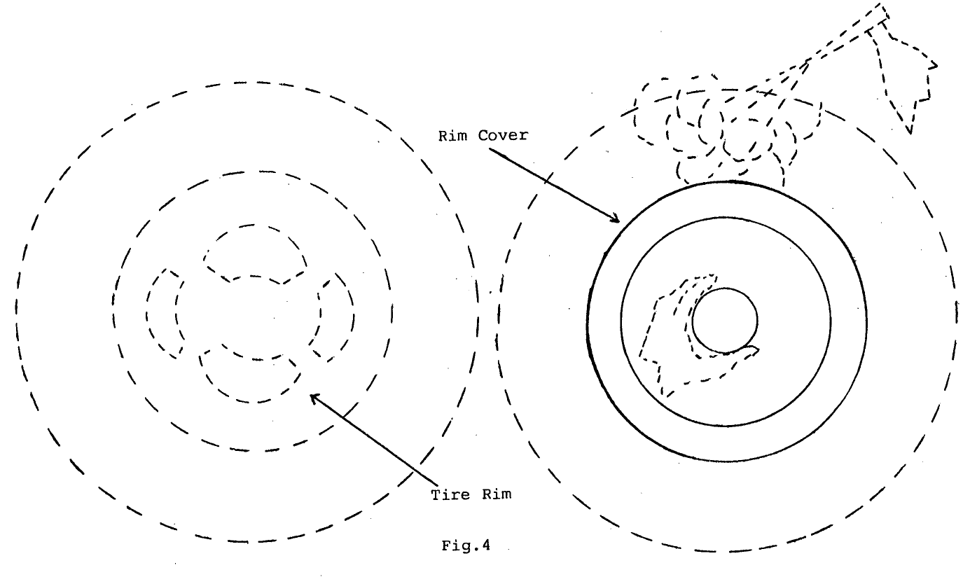

4. Demonstration Drawing (FIG. 4): This drawing is to show the intended use of the rim cover.

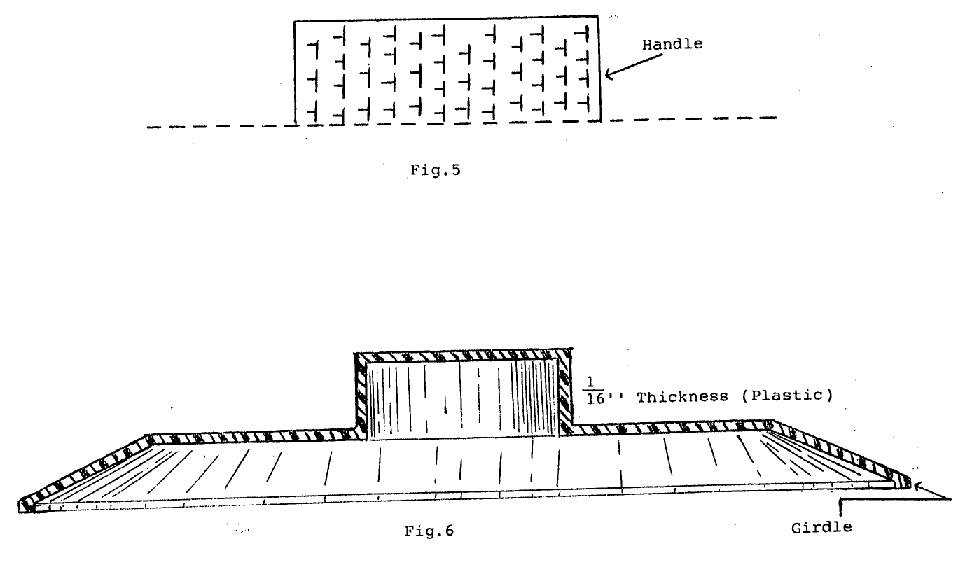

5. Handle (FIG. 5): This side view drawing shows the exterior of the handle which is textured for grip.

6. Cut Away Drawing (FIG. 6): This side view shows a three dimensional cut away of the rim cover's configuration.

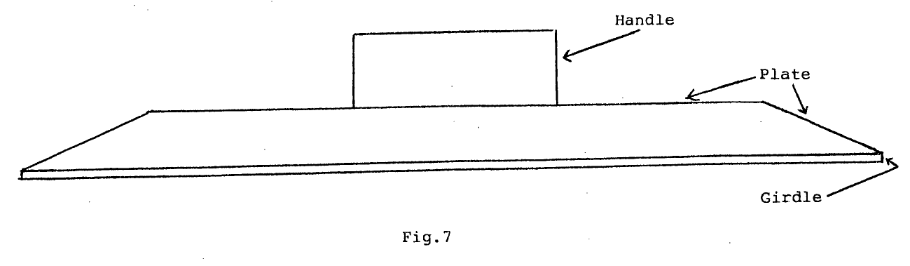

7. Section Name Drawing (FIG. 7): This side view drawing labels each section of the rim cover which is defined as follows: Handle, Plate, and Girdle.

The handle is cylindrical closed at the top with a textured side surface for grip. The plate extends over diameter of the rim. The outer edge is slanted to allow for a better spraying angle. The girdle is a ⅜″ wide band that follows the outer circumference of the plate. Its purpose is to completely enclose the rim to maximize protection.

1. What I claim as my invention is an automobile/vehicle wheel rim cover. It has been designed to impede chemical protectants used to detail automobile/vehicle tires from coming into contact with the tire rim when these chemical protectants are applied with hand pump type spray bottles, aerosol applicators or other low pressure pumping application devices. When utilized the rim cover is placed over the outside surface of the wheel rim to enclose it, separating this surface from the outside tire surface being sprayed. The result is that the rim cover impedes excessive spray and mist from settling on the wheel rim.
